(19) United States
(12) Patent Application Publication
(10) Pub. No.: US 2002/0016826 A1
(43) Pub. Date: Feb. 7, 2002

(54) Firewall apparatus and method of controlling network data packet traffic between internal and external networks

(76) Inventors: Olof Johansson, Austin, TX (US); Svante Carlsson, Karlskrona (SE); Joel Lindholm, Lulea (SE); Mikael Sundstrom, Lulea (SE); Andrej Brodnik, Ljubljana (SI)

Correspondence Address: Steven S. Payne, 8027 ILIFF Drive, Dunn Loring, VA, 22027, US

(21) Appl. No.: 09/904,837

(22) Filed: Jul. 16, 2001

(30) Foreign Application Priority Data
Feb. 7, 1998 (SE) 9802415-1

(51) Int. Cl. G06F 15/16

(52) U.S. Cl. 709/207; 709/245

(57) ABSTRACT

A firewall (3), controlling network data packet traffic between internal and external networks (1,5,4), comprising filtering means, in dependence of the contents in data fields of a data packet being transmitted between said networks, selecting from a total set of rules a rule applicable to the data packet, whereby said packet is blocked or forwarded through the firewall (3). A 2-dimensional address lookup means (8) performs a 2-dimensional lookup of the source and destination addresses of the packet in a set of address prefixes, each prefix having a subset of rules of the total set of rules, in order to find a prefix associated with said source and destination addresses, and rule matching means (10), performs—based on the contents of said data fields—a rule matching in order to find the rule applicable to the data packet.

### FIELD OF THE INVENTION

The present invention relates generally to a firewall apparatus and a method of controlling network data packet traffic between internal and external networks, and more particularly to a firewall apparatus comprising filtering means, depending on the contents in data fields of a data packet to be transmitted between said networks, selecting from a total set of rules a rule applicable to the data packet, whereby said packet is blocked or forwarded through the firewall, and a method thereof.

### DESCRIPTION OF THE PRIOR ART

An important issue for most Internet connected organisations is security and consequently firewalls are becoming an important part in most computer and network security strategies in most organisations. Users accessing the webserver or other public services of the organisation must not be able to gain access to internal services such as accounting systems, Internet information servers and other possibly sensitive company information. The service of the systems must not be interrupted—servers and work-stations need to be protected against denario-of-service (DOS) tags from users on the Internet.

A firewall, or filtering router, is a device that works basically the same way as a router. That is, it receives packets on an in-interface, inspects the packets destination address, and forwards the packet on the correct (with respect to the destination address) out-interface. However, a firewall performs a much more thorough inspection of each packet. The source and destination address, source and destination ports, protocol field, flags, and options are also inspected and compared to a list of firewall rules. Depending on which rule matches the packet, the firewall might decide not to forward the packet, for instance if a blocking rule is matched.

In addition to unauthorized access there are other threats that arise when an organisation is connected to the Internet. The bottom line is that data received from unknown sources cannot be trusted. Scanning for viruses and troyan hourses in email and webpages are duties performed by some prior art firewalls.

Further, as network bandwidth is increasing, the performance of the firewalls are becoming an important issue.

Firewalls can work on many different levels and provide different kind of functionality for scanning data passing it. However, the basic functionality of all firewalls is to implement filtering based on the contents of the network (IP=Internet Protocol) and transport (UDP, TCP=Transmission Control Protocol and ICMP=Internet Control Message Protocol) layer headers. Without such IP filtering all other functionality, such as data scanning, is useless, that is users on the internal network might just as well cofigure their network applications not to go through the scanner to connect to remote servers and thus bypass all security functionality.

Companies or organisations are connected to the Internet for different reasons, for example in order to publish information about a company, its products and services on the web, get access to information available on the Internet, and correspond via email.

The company often has internal information that users on the Internet must not be able to access, such as Internet information servers, file servers etc. The most common configuration is to allow connections from the Internet to a set of servers (web, email, and other public services), but to deny access to other hosts (for example intranet servers). To achieve this a “demilitarized zone” (DMZ) is established. Connections to computers in the DMZ can be made from the Internet as well as from the intranet, but access to the intranet from the Internet is restricted. In prior art networks an internal network, such as an intranet is connected to the demilitarized zone via a firewall and the DMZ is connected to the Internet via a router. Consequently, network traffic can pass freely between the Internet and the DMZ, which is completely unprotected from users on the intranet. A reason for this is that prior art firewalls also lack the possibility to connect more than two networks—an internal and an external network.

Other firewalls have three network interfaces. Here, restrictions can be made concerning traffic between the Internet and the DMZ as well as the intranet. Some restrictions are made for traffic to and from hosts in the DMZ, for example the web server only needs to be accessable on the HTTP (Hypertext Transfer Protocol) port. Internet users should not be able to connect to any other services. However, users on the intranet might want to be able to access the web server in more ways than the Internet users for administrative purposes, thus more access should be granted inbetween these two networks. Similar rules are needed for the email server; SMTP (Simple Mail Transfer Protocol) connections should be allowed from the Internet, but reading email should only be possible for certain allowed hosts on the intranet, and possibly also from some host on the Internet.

In a firewall environment the number of machines in the DMZ is for example 30. The rules for the machines in the DMZ can be different for each machine, but the number of rules per machine is fairly low, for example 10-15. More rules might apply for traffic from the intranet to the DMZ, but these are likely to be more general. Thus, a fairly low number of rules are valid for all machines in the DMZ.

Further, rules regarding traffic between the Internet and the intranet(s) are in most cases few, if any at all. Most traffic should be blocked. However, traffic initiated from the intranet might be allowed.

As the number of users on the Internet grows, the public servers will be visited more frequently, causing more traffic. The traffic to and from the intranet increases as the intranet users are taking part of the increasing amounts of information available on the Internet. Consequently, bandwidth requirements is increasing. This puts greater demands on the performance of the firewalls used.

Thus, the main task for a firewall is packet filtering, that is given an IP packet and a set of rules, which rule should be applied on this packet? If several rules match the same packet a policy needs to be defined to specify which rule to pick. There are two prior art solutions known to this problem. One solution is to pick the rule matching the most number of fields of a packet, and if two rules match the same number of fields, but different ones, an order needs to be specified between them. This is used in the packet classification algorithm by Borg and Flodin, Born, N. Flodin, Malin, packet classification, June 1997; Borg, N., A Packet Classifier for IP Networks, Masters Lic., Lule\dot{a} University of Technology, February 1998. Another solution is to define an order between the rules and using that order to define which rule to pick. An advantage of the second solution is that it gives better flexibility when defining filter rules, and the net NetBSD firewall code utilize this method.

A filter rule comprises a set of criteria that has to be fulfilled, and an action to perform when they are fulfilled. The criteria are based on IP source and destination addresses (32-bit prefixes), IP protocol field (8 bit-integer), whether or not the packet has IP options set, and what these options are (integer) due IP/TCP source and destination port numbers (2 16-bit integer ranges), TCP header flags (3 bits), ICMP headerr type and code fields (2 8-bit integers), what interface the packet was read from (8+8 bits), and what interface the packet is to be forwarded to (8+8 bits).

Most firewalls today do not address the rule matching problem in particular. It is common to have a linked list (or an array) of rules, comparing the packet with each and every one of these until a match is found. However, this is not efficient. Another approach is hashing of the rules. Further, if the method for resolving ambiguities among the rules, that is two rules match the same packet, most implementations solve the problem by defining the first or last matching rule as the one to follow.

A prior art firewall, PIX firewall by Cisco Systems, is a connection oriented security device that protects an internal network from an external network. The PIX firewall is a very expensive device and it has an upper limit of about 16000 simultaneous connections. The main part of the PIX firewall is a protection scheme based on the adaptive security algorithm (ASA), which offers stateful connection oriented security. ASA tracks the source and destination address, TCP sequence numbers, port numbers, and additional TCP flags of each packet. This information is stored in a table, and all inbound and outbound packets are compared against entries in the table. Hence, information of each connection established has to be stored during the lifetime of the connection, and thus, the number of connections possible are defined by the memory capacity available. A fully loaded Cisco PIX firewall can operate at about 90 Mbite/s. However, the Cisco PIX firewall also supports port address translation (PAT), whereby more than 64000 internal hosts can be served by a single external IP address.

A prior art packet filter called ipf (IP filter) is included with the standard distribution of net BSD 1.3.

The rule sets in ipf are split up on the interfaces on which they are valid. Furthermore, the rules are checked twice, first when the packet enters the host and second when it leaves the host. Rules only valid for inbound packets are not added to the list of rules checked at the output port, and vice versa. The data structure is basically an optimized linked list.

The Exokernel, Engler, D., Kaashoek, M. F., O'Tool Jr, J., Exokernel: An operating system architecture . . . , Proceedings of the 15th ACM symposium on Operating Systems principles, December 1995, uses a different approach to handle packet demultiplexing called DPF, Angler, D., Kaashoek, M. F., DPF: Fast, flexible message demultiplexing . . . , Engler, D., Kaashoek, M. F., Computer Communication Review, Vo. 26, No. 4, October 1996. The rules are written in a special programming language, and thereafter, the are compiled. The compiler knows about all the rules specified, the generated code can be optimized for the expected traffic patents.

### SUMMARY OF THE INVENTION

It is an objective of the present invention to provide an improved firewall apparatus and a method of controlling network traffic between internal and external networks providing an efficient address lookup and rule matching process in order to achieve an effective and fast IP packet filtering, and and an unlimited number of possible connections through the firewall.

This is accomplished by the firewall apparatus and method according to the invention, wherein the set of rules needed to be searched linearity is reduced by segmenting the rule set. The firewall according to the invention comprises 2-dimensional address lockup means performing a two step lookup, first of source and destination addresses of the packet in a set of address prefixes. Each prefix is associated with a subset of rules of a total set of rules. A liner search is performed on the resulting subset of rules in order to find the rule applicable to the present data packet.

Another object of the invention is to provide a fragment machine fragmenting packet being too large to be handled as they are.

Still another object of the invention is to provide network address translation means translating internal source addresses to external source addresses of a packet transmitted from the firewall or external source addresses to internal source addresses of a packet transmitted into the firewall.

Another further object of the invention is to provide network address translation means translating internal source addresses to external source addresses of a packet transmitted from an internal network to an external network, or external source addresses to internal source addresses of a packet transmitted from the external network to the internal network.

Still another object of the invention is to provide hole punching means performing a temporary exception from an external-to-internal blocking rule for a connection initiated from the internal network, wherein a returned channel for packets transmitted from the external network to the internal network are established through the firewall.

A further object of the invention is to provide a firewall capable of handling at least 1000 unique rules.

Advantageous of the firewall and the method thereof according to the present invention are the unlimited number of possible simultaneous connections, the fast IP filtering, and the great number of possible rules supported.

Another object of the firewall according to the invention is to provide a firewall comprising a router.

### BRIEF DESCRIPTION OF THE DRAWINGS

In order to explain the invention in more detail and the advantages and features of the invention preferred embodiments will be described in detail below, reference being made to the accompanying drawings, in which

FIG. 1 is shows common network topology comprising the firewall according to the invention,

FIG. 2 is a block diagram of the firewall according to the invention,

FIG. 3 is an illustrative view of a partition of a two dimensional dence chunk,

FIG. 4 is an illustrative view of the data structure according to the invention,

FIG. 5 is an illustrative view of a class (0,0) tile,

FIG. 6 is an illustrative view of a class (1,1) tile,

FIG. 7 is an illustrative view of a class (1,2) tile,

FIG. 8 is an illustrative view of a class (2,1) tile,

FIG. 9 is an illustrative view of a class (1,3+) tile,

FIG. 10 is an illustrative view of a class (3+,1) tile,

FIG. 11 is an illustrative view of a class (2+,2+) tile,

FIG. 12 shows an example of an unsuccessful search for a particular query key in a Patricia Tree containing six keys, and

FIG. 13 shows the Patricia Tree resulting from an insertion of the query key from the unsuccessful search according to FIG. 12.

### DETAILED DESCRIPTION OF THE INVENTION

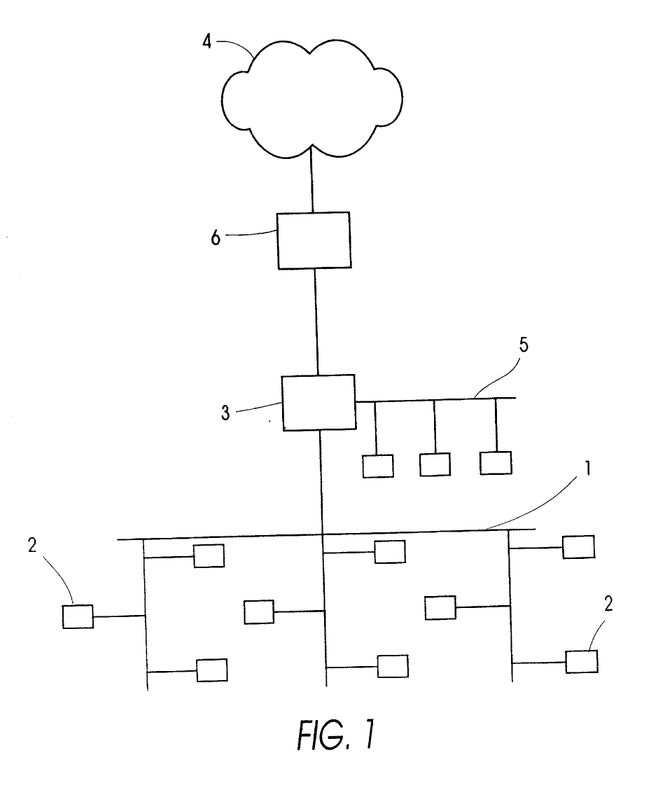

An example of a modern network topology from a company's or an organisation's point of view is shown in FIG. 1. An internal network 1, such as an Intranet comprises several network nodes 2 such as PCs, workstations, file servers etc, which are connected to a firewall 3. Companies or organisations connected to an external network 4 (Internet) intend to publish company related information, such as products and services, on the web, get access to information published by other companies or organisations on the Internet, and correspond via email. However, the company might have internal information that users on the Internet not are allowed to access, for example information available via the Intranet information servers, file servers etc. Thus, to allow Internet users to access public information they are allowed to be connected to a limited set of servers, for example the web, email etc., and denied to access information on other hosts, such as Intranet servers. The public servers are available in a “Demilitarised Zone” (DMZ) 5, which is connected to the firewall 3. Further, the firewall 3 is connected to the Internet via a router 6, and, hence, connections to nodes in the DMZ 5 can be made from the external network or Internet 4 as well as from the Intranet 1, but accesses to the Intranet 1 from the Internet 4 is restricted.

In the following description, numerous specific details, are provided in detail in order to give a more thorough description of the present invention. It will be obvious for those skilled in the art that the present invention may be practiced without these specific details. Some well-known features are not described in detail so as not to make the present invention unclear.

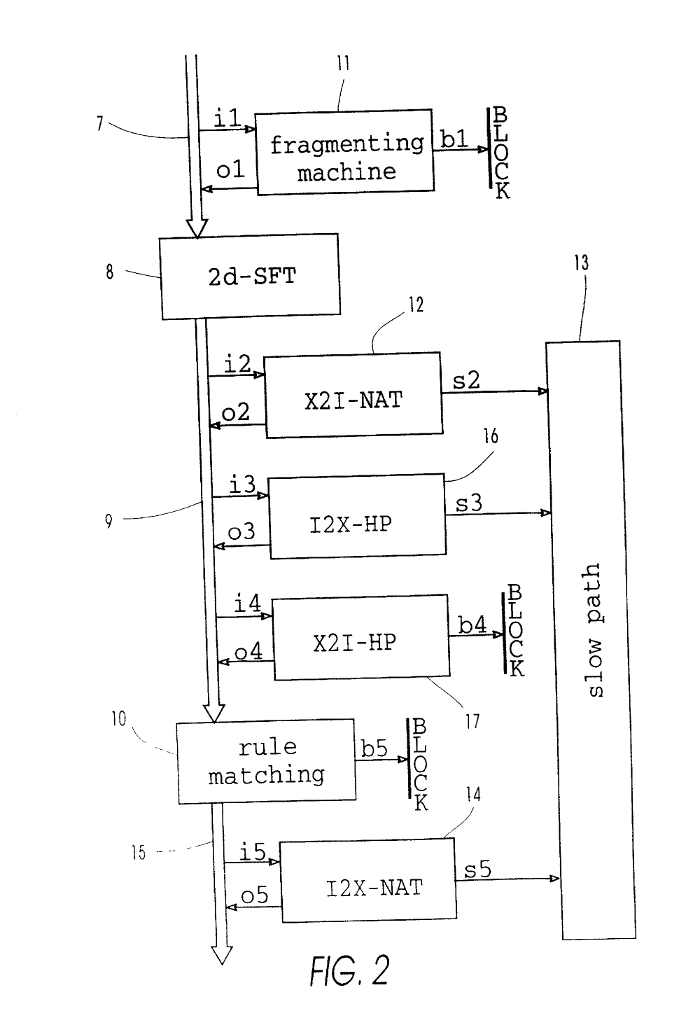

One embodiment of the firewall and the different modules in the fast path and how the filtered packets flows through according to the invention is shown in FIG. 2.

In a simple case a packet is received from a network 1, 4, or 5 in a firewall input connection 7 and is applied to the input of 2-dimensional address lookup means or a 2d-SFT block 8. A intermediate connection 9 connects the 2d-SFT and rule matching means or block 10, wherein the packet is either passed (down) or blocked b5. However, in order to work properly the firewall according to the invention has a number of additional modules.

In this embodiment a lookup of source address and destination address are performed in the 2d-SFT block 8, resulting in a rule or actually a short list of rules. The rule list remains in the rule matching block 10 until the list is searched and a matching rule is found. Additionally, information of whether the packet might need to be processed by the other modules or not are generated by the 2d-SFT lookup. Some of these decisions are taken during the rule matching which means that the rule matching actually starts before entering the block, as illustrated in FIG. 2. The 2d-SFT block 8 is described in detail below.

When a packet is too large to be sent over a link, it is fragmented in a fragmenting apparatus or machine 11. This means that everything that follows the IP header is cut into pieces (fragments) and each fragment is supplied with its own IP header. The additional fragments flag and the fragment offset is set in each fragment to indicate if it is the last fragment or not, and to record where the data of the fragment fits into the original (unfragmented) packet. These fields are checked to determine if the packet is applied to the input i1—connected to the connection 7—of the fragmenting machine 11 or not.

When a packet is fragmented, only the first fragment, the fragment header, contains the transport header (TCP, UDP, or ICMP header). This means that the following fragments can not be matched against a rule involving for example ports.

The fragmenting machine 11 collects fragments from each fragmented packet until the fragment header arrives (fragment does not necessarily arrive in order). Then, the pieces of information present only in the fragment header are stored in the entry associated with that fragmented packet, and the collected fragments are applied to the output o1, connected to the connection 7, with the fragment header first. Each fragment that is transmitted from the fragment machine is supplied with the fragment header information, so that it can be processed by the filter just as if it was an unfragmented packet.

When all fragments of a fragmented packet has been received in the fragmenting machine 11, the entry for the packet is removed.

At some points, the fragmenting machine might also decide to block fragments. This happens when broken fragmented packets arrives (possibly as a result of an attack), if the number of collected fragments exceeds a certain limit, or simply as a result of garbage collection (old entries are removed to make place for new ones).

Network Address Translation (NAT) is commonly used when a company have an network with many internal IP addresses and only a few external (real) IP addresses. Some parts of IP address space are reserved for internal addresses, such as 10.*.*.*, 192.168.*.*, and 172.16.*.*. These addresses can freely be used on internal/private networks. However, they must never be visible on the external. Therefore, the firewall is setup to translate internal source addresses to external source addresses as packet goes from the internal to an external network. For packets going in the other direction, the external destination address is translated to an internal address as the packets goes through the firewall. In order to use map many internal addresses onto a few external addresses, ports are also used.

For example, the firewall is setup to map internal addresses from 10.1.0.0 to 10.1.255.255 (2¹⁶ addresses) to external addresses 194.22.187.0 to 194.22.187.255 (2⁸ addresses) using ports 20000 to 20255 (2⁸ ports).

When a connection is initiated from 10.1.1.1 port 4000 to 130.240.64.46 port 6000, an address a and a port p, so that (a,p) does not collide with any other NAT connection, is picked from the address and port range. Then, each outgoing, internal to external (I2X), packet from that connection, the source address 10.1.1.1 and port 4000 are replaced by a and p respectively. For each incoming, external to internal (X2I) packet, the destination address a and port p are replaced by 10.1.1.1 and 4000, respectively.

In this way, the 256 external addresses together with the 256 ports can represent the 65536 addresses of the internal network.

As a result from the 2d-SFT lookup, also information about if a packet is subject to an external to internal address translation is achieved, and the packet is applied on the input i2 of an X2I-NAT block 12 performing the external to internal address translation. Therefore, the overhead for performing X2I-NAT lookup is removed on all packets not requiring translation. For packets where X2I-NAT lookup is performed, the packets are sent to slow path means 13 via its slow path output s2 in the case of failure since updates of the NAT data structure are dealt with therein. When a successful X2I-NAT lookup is performed, the address and ports are changed and a rule matching of the new source-destination pair is retrieved before the packet is sent to the next filtering step via its output o2.

Also, as a result from the 2d-SFT lookup or from the X2I-NAT lookup, it is clear if the packet is subject to internal to external (I2X) address translation. This is performed basically in the same way as X2I-NAT, but is performed as the last filtering step. A packet subject to internal to external (I2X) address translation received from the output connection 15 of the rule matching block 10 is applied on the input i5 of an I2X-NAT block 14, performing the internal to external address translation. For packets where I2X-NAT lookup is performed, the packets are sent to the slow path means 13 via its slow path output s5 in the case of failure since updates of the NAT data structure are dealt with therein. When a successful I2X-NAT lookup is performed, the address and ports are changed and the packet is transmitted to the appropriate network via its output o2 and the output connection 15.

The reason for having X2I-NAT as the first step after 2d-SFT lookup and I2X-NAT as the last step is that filtering rules are given with respect to internal addresses, which are fixed, and not NAT address, which are assigned dynamically.

Usually, most of the traffic that goes from an external network 4 to an internal network 1 is blocked, to protect the internal network. However, hosts on the internal network are usually allowed to access hosts on the external network 4. In order to receive any return traffic from the external, a temporary exception from the external-to-internal blocking rule must be made for connections initiated from the internal network. This is referred to as hole punching (HP), i.e a hole for returning packets are punched through the firewall. The hole exists only during the lifetime of the connection, and does only affect packets from the connection.

Hole punching also keep track of the TCP sequence numbers in order to protect hole punched connections from being hijacked. Therefore, it is necessary both to perform HP lookup on outbound (I2X) packets performed by an I2X-HP block 16 and inbound (X2I) packets performed by an X2I-HP block 17.

As a result from the 2d-SFT lookup or from X2I-NAT lookup, we know if the packet is subject to internal to external (I2X) or external to internal (X2I) hole punching. This means that we can avoid the overhead from performing HP lookups on packets that can not be subject to hole punching. An outbound packet subject to hole punching is applied to an input i3 of the I2X-HP block 16, whereby the source and destination addresses and ports, and the protocol, are looked up in order to find an existing state. If no such state exists, the packet is sent to the slow path means 13 via its slow path output s3, wherein the HP data structure is updated and a state is created. If a matching state is found, it is update before the packet is sent to the next filtering step via another output o3.

The X2I-HP is performed in the same way. An inbound packet subject to hole punching is applied to an input i4 of the X2I-HP block 17, whereby the source and destination addresses and ports, and the protocol, are looked up in order to find an existing state. If no such state exists, an attempt to send the packet through a non-existent hole in a blocking rule has been made and the packet is blocked at its output b4. If a matching state is found, it is updated before the packet is sent to the next filtering step via another output o4.

Again referring to the 2d-SFT block 8, in dependence of the contents in data fields of a data packet being transmitted between said networks, a rule applicable to the data packet is selecting from a total set of rules, whereby said packet is blocked or forwarded through the firewall. In order to reduce the set of rules to be searched linearly, the rule set is segmented. According to the invention, this is performed by means of a 2-dimensional lookup of the source and destination addresses of the packet in a set of address prefixes, wherein each prefix has a subset of rules of the total set of rules, in order to find a prefix associated with the source and destination addresses. Then, based on the contents of said data fields, a rule matching is performed by the rule matching means 10 in order to find the rule applicable to the data packet.

When performing the 2-dimensional lookup of the addresses, each rule is seen as covering a rectangular area of a 2-dimensional plane, wherein the offset and size of the rectangle is determined by the address prefixes and prefix lengths. Hence, the lookup is considered to be the same problem as finding the rectangle surrounding a point in the plane. To simplify the lookup, a restriction is made to assure that each point in the plane is covered by one and only one rectangle, resulting in an easier lookup procedure.

After the 2-dimensional address lookup is performed the lookup continues with a resulting subset of rules associated with the current prefix found. The address fields are, however, not used in the final rule matching. Thus, if a rule is not valid for the addresses of the current packet it is not in the list of rules resulting from the address lookup.

Since each rule is represented by a rectangle covering a part of the total address space and several rules may be applicable to the same addresses, the rectangles may overlap. However, in order to make the method according to the invention to operate in the proper way overlapping rectangles are not allowed. Consequently, in order to fulfill the non-overlap criteria the following steps have to be performed:

1. For each rule, create the rectangle in the address space.

2. Create a set containing only the newly created rectangle. This set will be called the compare set.

3. For all rectangles already in the plane; compare it to each rectangle in the compare set.

4. If they are overlapping, cut out the non-overlapping parts. The rule list of the overlapping parts is assigned the rule from the new rectangle appended at the end thereof.

5. For all parts—if the part was a part of the rectangle already on the plane, return it to the plane. If not, add it to the set of rectangles to be compared.

6. If the compare set is none-empty, return to step 3. Rectangles already in the plane and which have already been compared can be left out.

7. At this state the compare set is empty. If any rectangles were overlapping the new one they are split up into smaller parts if needed, with the common parts having rule lists containing the new rule.

In another method to fulfill the non-overlap criteria there is not just a set of rectangles in the plane. Instead, each rectangle contains, apart from its coordinate and rule list index, a set of rectangles or subrectangles. Each of the subrectangles have an additional set of sub-rectangles. However, sometimes it is necessary to refer to the same subrectangle and to traverse a directed Acyclic graph (DAG) of rectangles depth.

There is always one root rectangle covering the whole plane. This represents the default to follow if all other comparison fail. The rule action is either blocked or allowed to pass depending on the configuration.

A rectangle called root is the root rectangle to which a rectangle new is to be added.

If the root and the new rectangles are of the same size the rules in the new rectangle is added to the rule list associated with the root rectangle.

Iterate over all subrectangles of the root rectangle. If the new rectangle can be completely covered by any of these, make a recursive call with the subrectangle as the root instead and then return.

Once again, iterate over all subrectangles in the root rectangle.

If a subrectangle can be completely contained in the new rectangle, it is moved from the root rectangle to the new rectangle. The rule list of the subrectangle and all rectangles under it needs to be modified to include the rule of the new rectangle as well.

If the subrectangle intersects with the new rectangle, a new rectangle is created comprising the common part of the two. The rule list of the intersecting rectangle is a combination of the original ones. Then, the new rectangle is added to both the original subrectangle and the new rectangle.

Once all rectangles are added to the DAG the graph can be traversed and the list of prefix-defined rectangles that is needed by the two dimensional lookup building code can be produced. The intersecting rectangle will be a proper prefix defined rectangle, but the rest of the surrounding rectangle after the subrectangles have been cut out may not be properly defined by prefixes.

When the data structure is used for filtering lookups as described above, the lookup is made in two steps. First a two dimensional address lookup is performed, resulting in an integer number. This integer is an index into an array of rules, wherein each rule specifies which fields to compare and what action to perform if a match was found. Each rule has a next field indicating which rule to continue with in case of a mismatch. The traversing of the rule list is continued until a match is found, and when proper actions are taken in order to block or forward the packet.

The 2-dimensional prefix problem is solved as follows.

The address space or universe U is a 2 dimensional space consisting of integer pairs (s,d) satisfying: 0≦s<2³², 0≦d<2³².

A subset R of U satisfying: (s,d) ε R if s₀≦s<s₁, d₀≦d<d₁, wherein (s₀,d₀),(s₁,d₁) ε U is called a rectangle. Further, the pair of points [(s₀,d₀), (s₁,d₁)] uniquely defines R.

A rectangle defined by [(s₀,d₀),(s₁,d₁)], where s₁−s₀=s₁−2^{is}*kₛ=2^{is} and d₁−d₀=d₁−2^{id}*k_{d}=2^{id} for some non negative integers iₛ, i_{d}, kₛ, and k_{d} is called a prefix.

Given a point (s,d) ε U and a set of prefixes P={P₁,P₂, . . . , Pₙ}, such that P is a partition of U, the 2 dimensional prefix matching problem is the problem of computing i such that (s,d) ε Pᵢ.

The source-destination part of the firewall filtering problem is represented as a 2-dimensional prefix matching problem, where the set P is obtained by converting the routing table and the filtering rules into a partition of prefixes. Since each packet to be filtered requires a prefix matching, it becomes necessary to find a representation of P such that the prefix matching can be computed efficiently.

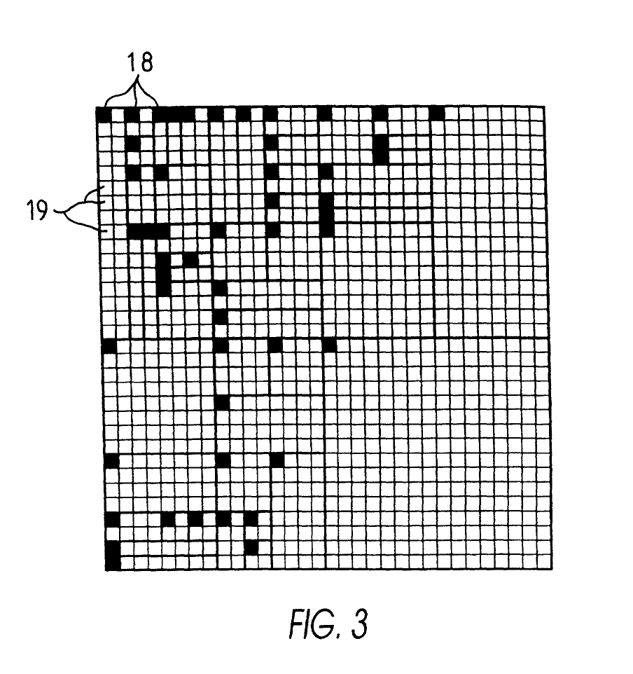

A number of prefixes that partitions a small 32×32 bits universe is shown in FIG. 3. Black squares 18 represents bits set (representatives) and white squares 19 represents not set bits. Note: point (0,0) is located in the upper left corner in FIG. 3.

For each prefix P=[(s₀,d₀), (s₁,d₁)] ε P the point (s₀,d₀) is chosen as a representative of P. Further, let p p={P₁, P₂, . . . pₙ}={(s₁,d₁) , (s₂,d₂) , . . . , (sₙ,dₙ)} denote the set of representatives of the prefixes in P.

Given a point (s_{d},d_{d}) ε U, for each (s,d) Ε U, such that S_{d}≧s and d_{d}≧d, (s_{d},d_{d}) is a dominating point of (s,d), or alternatively, (s,d) is dominated by (s_{d},d_{d}).

Given a pair of points (s₁,d₁), (s₂,d₂) ε U, the distance between the points under the norm L_{∞}. is given by:

Now, given a point p=(s,d), the problem of finding the matching prefix in P is equivalent to the problem of finding the closest dominating point p in p under the norm L_{∞}, i.e. the dominating point of pᵢ ε p of p minimizing the L_{∞}-distance between pᵢ and p. Hence, it is sufficient to represent only the dominating points instead of the prefixes themselves.

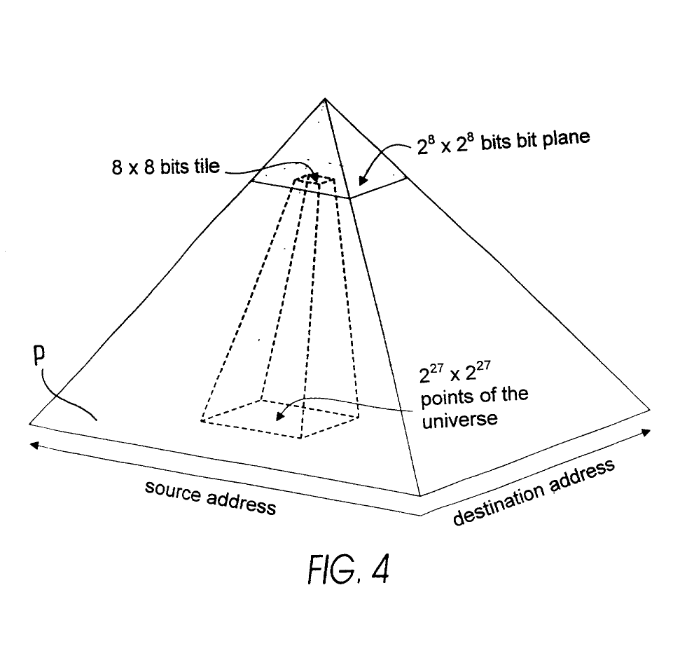

As shown in FIG. 4, the set p is conceptually represented as a 2³²×2³² points bit matrix, where bit p is set if p ε p. To reduce the space required for the representation, we actually represent p as a four level 2⁸⁺⁸-ary tree. Each level is (again) conceptually represented as a 2⁸×2⁸ bits bit matrix where bit (s,d) is set if there is a dominating point in the sub-tree below. That is, at level 1 (the top level), bit (s,d) represents the presence or absence of a dominating point in the rectangle [( 2²⁴*s,2²⁴*d), (2²⁴*(s+1), 2²⁴*(d+1))] of U.

The actual representation of a level is a 2-dimensional dense chunk or simply a 2d-chunk. How and when a level can be represented by a 1-dimensional dense chunk is discussed later. A 2d-chunk consists of 32×32 tiles, where each tile represents 8×8 bits. Since the points defining a tile are dominating points of prefixes, not all 2⁶⁴ kinds of tiles are possible. In fact, we impose a restriction on the tiles so that only 677 different kinds are possible.

If there is a point in a tile T (a point in some of the sub-universes represented by one of the bits in the tile) having its closest dominating point in another tile T_{d} then all points in T have their closest dominating points in T_{d}. The definition of a dominating point is extended to a dominating tile. The tile T_{d} is called a dominating tile of T, or alternatively, tile T is dominated by the tile T_{d}.

In order to fulfill the requirement of the previous definition the following lemma is needed.

If P=[(s₀,d₀),(s₁,d₁)] is a prefix satisfying s₁−s₀>1, then [(s₀,d₀),(s₀+2ⁱ,d₁)] and [(s₀+2ⁱ, d₀) , (s₁,d₁)], wherein s₁−s₀2ⁱ for some none-negative integer i, are also prefixes. The lemma for the other dimension is symmetrical.

By the lemma above, a prefix can be cut into 2 parts whenever required. Hence, given a set of prefixes P_{d} with representatives in the tile T_{d} we can repeatedly cut them until all prefixes has their endpoints in the same tile, in both dimensions, to fulfill the requirement above. This is called tile cutting and a crucial part of the construction of dense2d chunks.

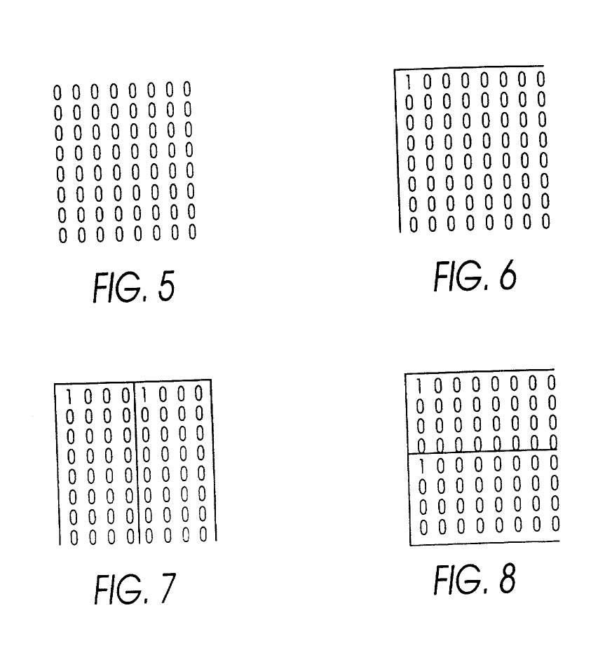

The different kinds of tiles are divided into seven classes shown in FIG. 5-11. For each class the/a tile is shown as a bit matrix in (asterisks represents bits that can be either 0 or 1). For each bit set (not *) and tile class there are also lines indicating the guaranteed boundaries of the subset dominated by that bit (point). Note that a set bit in a tile can typically dominate points in other tiles to the right and/or below. We also give the number of different kinds of tiles in the class and distinguish between natural and restricted tile classes. Finally, we describe how the tiles are be represented/encoded in the dense2d chunk.

A class (0, 0) tile is shown in FIG. 5. No bit is set: natural, 1 kind, and always dominated by a tile T_{d} from class (1, 1), (1, 2) , (2, 1) , (1, 3+) , or (3+, 1). Finding the dominating point of a point in bit (s_{b},d_{b}) in a class (0, 0) tile is exactly the same as finding the dominating point of the corresponding point in bit (s_{b},d_{b}) of its dominating tile T_{d}. Hence, a class (0, 0) tile can, and should, always be encoded exactly the same way as its dominating tile T_{d}.

A class (1, 1) tile is shown in FIG. 6. One bit is set: natural, 1 kind, and possibly dominates class (0, 0) tiles to the right and/or below. Since all points within this tile has the same closest dominating point, we simply encode a reference to that point within the tile itself

A class (1, 2) tile is shown in FIG. 7. Two bits in the first row (D-dimension) are set: natural, 1 kind, and possibly dominates class (0, 0) tiles below. Can not dominate class (0, 0) tiles to the right.

There are two closest dominating points of the points in this tile, one for the points in the left half, and one for the points in the right half. We encode references to both these dominating points as an array of length 2, and can then use the left/right half of the query point as indices.

A class (2, 1) tile is shown in FIG. 8. Two bits in the first column (S-dimension) are set: natural, 1 kind, and possibly dominates class (0, 0) tiles to the right. Can not dominate class (0, 0) tiles below. There are two closest dominating points of the points in this tile, one for the points in the top half, and one for the points in the bottom half. References to both these dominating points are encoded as an array of length 2, and can then use the top/bottom half of the query point as indices.

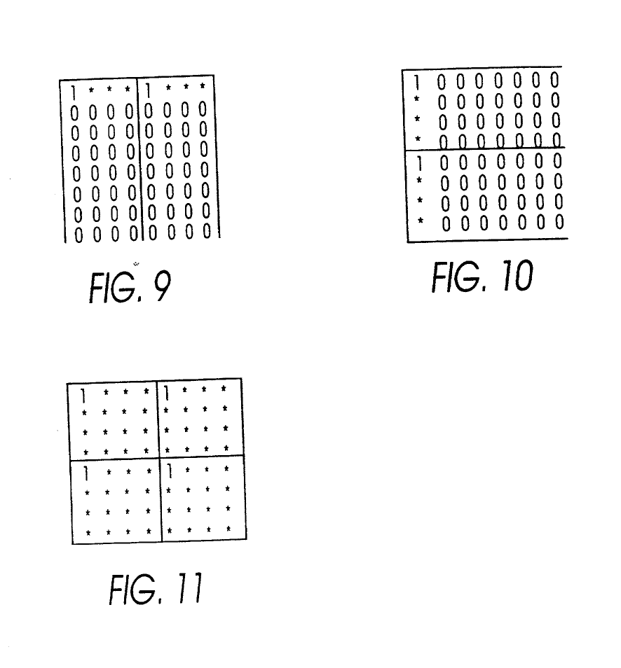

A class (1, 3+) tile is shown in FIG. 9. Three or more bits in the first row are set: natural, 24 kinds, and possibly dominates class (0, 0) tiles below. Can not dominate class (0, 0) tiles to the right. There may be many dominating points of the points in this class of tiles. It is necessary to encode the kind of the tile since there are 24 different kinds of tiles. Further, for each bit set in the first row, a pointer to the the dominating point below (if there is only one) or to the next level chunk (if there several dominating points) are encoded. Finally, a reference to the first pointer is encoded (a base pointer). In this way, the dominating point (or a reference to the next level chunk) of a query point (s,d) can be found by simply inspecting in which column the d is and together with the kind of the chunk perform a table lookup to retrieve a pointer offset x, and finally retrieve the pointer x pointers away from the base pointer. Note that any next level chunk only needs to be one (D-)dimensional since all representatives in the tile lies on the same S-coordinate.

A class (3+, 1) tile is shown in FIG. 10. Three or more bits in the first column are set: natural, 24 kinds, and possibly dominates class (0, 0) tiles to the right. Can not dominate class (0, 0) tiles below. There may be many dominating points of the points in this class of tiles. It is necessary to encode the kind of the tile since there are 24 different kinds. Further, for each set bit in the first column, a pointer to the the dominating point below (if there is only one) or to the next level chunk (if there several dominating points) are encoded. Finally, a reference to the first pointer is encoded (a base pointer). In this way, the dominating point (or a reference to the next level chunk) of a query point (s,d) can be found by simply inspecting in which row the s is and together with the kind of the chunk perform a table lookup to retrieve a pointer offset x, and finally retrieve the pointer x pointers away from the base pointer. Note that any next level chunk only needs to be one (S-)dimensional since all representatives in the tile lies on the same D-coordinate.

A class (2+, 2+) tile is shown in FIG. 11. Two or more bits are set in both the first row and the first column: restricted, 625 kinds, can not dominate another tile, and can not be dominated by another tile. There are typically many dominating points in this class of tiles. The encoding is performed exactly as for class (1, 3+) and (3+, 1) tiles. However, a restriction is imposed to reduce the number of different kinds before performing the actual encoding. The first task is to impose a restriction similar to the tile restriction of Definition 8 on each bit. Then a pair of bit vectors of length 8, Sv and Dv, is computed wherein

Sᵢ=1 if there is a bit set in the ith row, and 0, otherwise

Dᵢ=1, if there is a bit set in the ith column, and 0, otherwise

A new tile is finally created, by computing the product of Sv and Dv^{T} using matrix multiplication, and encoded.

As in class (1, 3+) and (3+, 1) tiles, one dimensional sub-levels may be provided also in this case. It is checked whether all representatives in a bit, containing more than one representative, is in the same row in U, which means that the S-dimension collapses, or on the same column in U, which means that the D-dimension collapses.

A further description of the data structures used in the firewall for representing NAT and HP entries.

In both cases, the pair of IP addresses saddr and daddr, the pair of ports sport and dport, and the protocol proto of the processed packet are used as key in the lookup. The first step in the lookup is to compute a hash value. This is accomplished using very simple and fast instructions such as bit shifts bit-wise logical operators. Using the hash value as index, a 16 bits pointer is then retrieved from a large array (the Hash table).

The pointer is either 0, which means that the lookup failed (empty) or refers to the root of a Patricia tree, which is a very efficient data structure for representing small sets of keys. If the pointer refers to a Patricia tree, a key is built by concatenating the bit patterns of saddr, daddr, sport, dport, and proto. The key is then used when searching the Patricia tree as described in the next section.

A Patricia Tree, is a binary tree that treats query keys as bit arrays, and uses a bit index in each internal node to direct the branching. Searching is accomplished by traversing the tree from the root to a leaf. When visiting an internal node with bit index i, bit i of the query key is inspected to determine whether to continue the search in the left (if the bit is 0) or right (if the bit is 1) sub-tree. The traversal stops when arriving at a leaf. To determine if the query key is present in the table or not, the query key is then compared to the key stored in that leaf. If the two keys are equal, the search is successful.

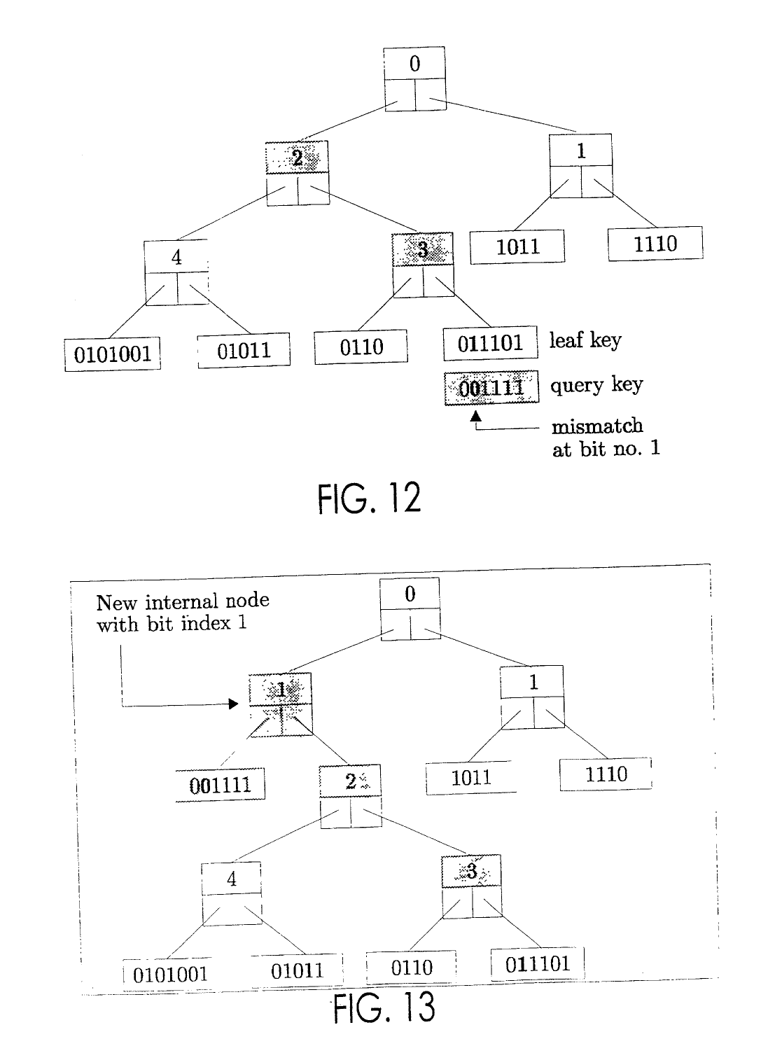

FIG. 12 illustrates an example of an unsuccessful search for the query key 001111 in a Patricia Tree containing six keys. Bits no. 0, 2, and 3 are inspected during the traversal, which ends at the leaf with key 011101. As the query and leaf keys are compared, a mismatch is detected in bit no. 1.

With respect to the bit indices stored in the internal nodes, a Patricia Tree is heap ordered. That is, any internal node, except the root, has a bit index greater than the bit index of its parent. It follows that all keys stored in a sub-tree rooted at a node with bit index i are identical up to, and including, bit i−1.

Insertion is accomplished by first performing an unsuccessful search, and recording the index i of the first mismatching bit in the comparison of the query and leaf key. Two new nodes are then created, a new internal node with index i and a leaf node for the query key. Depending on whether the i th bit of the query key is 0 or 1, the leaf is stored as the left or right sub-tree, respectively, of the internal node. By using the other sub-tree field as link field, the internal node is then inserted directly above the node with smallest bit index larger than i in the path traversed from the root to the leaf.

FIG. 13 shows the Patricia Tree resulting from inserting the query key from the unsuccessful search of the previous example in FIG. 12. A new internal node with bit index 1 is created, and inserted between the nodes with bit indices 0 and 2, in the path traversed from the root.

The Patricia Hashing used for hole punching works exactly as described above —a simple Hash table lookup followed by a Patricia tree lookup. Most of the time, a leaf is reached directly, which means that it is not necessary to build a bit array from the parameters—these are compared directly to corresponding fields in the structure containing/representing the Patricia leaf.

One lookup function hp_lookup(iaddr, xaddr, iport, xport, proto) is provided that are used both for I2X-HP and X2I-HP. The only difference between these are the order in which the parameters are given. For I2X-HP, the function call is hp_lookup(saddr, daddr, sport, dport, proto) and for X2I-HP the call is hp_lookup(daddr, saddr, dport, sport, proto).

The lookup function returns a reference to a structure containing the Patricia leaf key, i.e. iaddr, xaddr, iport, xport, and proto, and a couple of other fields representing the state of the connection, for example TCP sequence numbers.

The Patricia Hashing for NAT is slightly more complicated than for HP. The reason is that three different addresses and ports, iaddr, naddr, xaddr, iport, nport, xport, are involved, as opposed to HP where only two addresses and ports are involved. This means that the difference between I2X and X2I becomes a little more tricky than just swapping addresses and ports in the lookup.

The problem is solved by letting the least significant bit of the hash value reflect if the lookup is I2X or X2I (this is essentially the same as using two hash tables). The structure containing the Patricia leaf keys for a NAT connection is the same for I2X and X2I and it contains all three addresses and ports.

There are two lookup functions, nat_i2x_lookup(saddr, daddr, sport, dport, proto) and nat_x2i_lookup(saddr, daddr, sport, dport, proto). Both functions uses the arguments to compute a hash value where the least significant bit is set to accordingly. If the resulting pointer refers to a Patricia node (internal node), the addresses, ports, and protocol are concatenated to create the bit array needed for traversing the Patricia tree. When the leaf structure is reached, the addresses, ports, and protocol are compared to the corresponding fields in the leaf.

When a packet is subject to I2X-NAT:

saddr (of the packet) is compared to iaddr (of the leaf structure)

daddr is compared to xaddr

sport is compared to iport

dport is compared to xport

proto is compared to proto

If all of these matches, the lookup is successful, and the source address and port, saddr and sport, of the packet are replaced by naddr and nport (of the leaf structure), respectively, before the packet is forwarded.

When a packet is subject to X2I-NAT:

saddr (of the packet) is compared to xaddr (of the leaf structure)

daddr is compared to naddr

sport is compared to xport

dport is compared to nport

proto is compared to proto

If all of these matches, the lookup is successful, and the destination address and port, daddr and dport, of the packet are replaced by iaddr and iport (of the leaf structure), respectively, before the packet is sent to the next processing step.

Updates of the HP and NAT data structures are performed by the EffNIX kernel (previously NetBSD) running on the BSP (processor 1) but most of the lookups are performed by the forwarding kernel running on the AP (processor 2). There are only one instance of the HP data structure and one instance of the NAT data structure. These resides in shared memory and are accessed by the two processors simultaneously. This results in a very interesting synchronization problem—one writer and one reader. The synchronization is solved by letting the update routines invalidate the leafs structures and nodes before changing anything (writing). The lookup routines checks that the accessed leafs and nodes are valid before and after they have been accessed, and also that they have not been changed during the access. If a race occurs and is detected (all dangerous race conditions are detected) the lookup fails and the packet is sent to the BSP and dealt with there (either a successful lookup followed by processing is performed, or the data structures are updated).

It should be apparent that the present invention provides a firewall apparatus and a method of controlling network data packet traffic between internal and external networks that fully satisfies the aims and advantages set forth above.

Although the invention has been described in conjunction with a specific embodiment thereof, this invention is susceptible of embodiments in different forms, with the understanding that the present disclosure is to be considered as an exemplification of the principles of the invention and is not intended to limit the invention to the specific embodiment illustrated.

1. A firewall (3), controlling network data packet traffic between internal and external networks (1,5,4), comprising filtering means, in dependence of the contents in data fields of a data packet being transmitted between said networks, selecting from a total set of rules a rule applicable to the data packet, whereby said packet is blocked or forwarded through the firewall (3), characterized by 2-dimensional address lookup means (8) performing a 2-dimensional lookup of the source and destination addresses of the packet in a set of address prefixes, each prefix having a subset of rules of the total set of rules, in order to find a prefix associated with said source and destination addresses, and rule matching means (10), performing—based on the contents of said data fields—a rule matching in order to find the rule applicable to the data packet.

2. A firewall according to claim 1, characterized by a fragmenting machine (11) fragmenting packets being too large to be handled and comprising fragment collecting means collecting packet fragments from a fragmented packet until a fragment header of said packet is received, fragment header storing means storing in an entry means information present in a fragment header field of the packet, fragment forwarding means forwarding packet fragments provided with fragment header information starting with the fragment header, wherein each fragment is processed by the filtering means as a regular unfragmented packet.

3. A firewall according to claim 1 or 2, characterized by network address translation means (12,14), translating in dependence of the information in the prefix internal source addresses to external source addresses of a packet transmitted out through the firewall (3), or external source addresses to internal source addresses of a packet transmitted in through the firewall (3).

4. A firewall according to claim 1 or 2, characterized by network address translation means (12, 14), translating in depending of the information in the prefix internal source addresses to external source addresses of a packet transmitted from the internal network (1) to the external network (4), or external source addresses to internal source addresses of a packet transmitted from the external network (4) to the internal network (1).

5. A firewall according to any of the preceding claims, characterized by hole punching means (16,17), based on the information in the prefix determining if said packet is subject to a temporary exception from an external-to-internal blocking rule for a connection initiated from the internal network, wherein a return channel for packets transmitted from the external network (4) to the internal network (1) is established through the firewall during the lifetime of the connection.

6. A firewall (3), controlling network data packet traffic between internal and external networks (1,5,4), comprising filtering means, in dependence of the contents in data fields of a data packet being transmitted between said networks, selecting from a total set of rules a rule applicable to the data packet, whereby said packet is blocked or forwarded through the firewall (3), characterized by a fragmenting machine (11) fragmenting data packets being too large to be handled and comprising fragment collecting means collecting packet fragments from a fragmented packet until a fragment header of said packet is received, fragment header storing means storing in an entry means information present in a fragment header field of the packet, fragment forwarding means forwarding packet fragments provided with fragment header information starting with the fragment header, wherein each fragment is processed by the filtering means as a regular unfragmented packet.

7. A method of controlling network data packet traffic between internal (1,5) and external networks (4) through a firewall (3), comprising the steps of,
in dependence of the contents in the data fields of a data packet being transmitted between said networks, selecting from a total set of rules a rule applicable to the data packet,
applying said rule on said packet,
and depending on the rule blocking or forwarding said packet through the firewall (3),
characterized in that said filtering comprises the further steps of:
performing a 2-dimensional lookup of the source and destination addresses of the packet in order to find a prefix associated with said source and destination addresses in a set of address prefixes, each prefix having a subset of rules of the total set of rules,
and based on the contents of said data fields of the packet, performing a rule matching on the subset of rules in order to find the rule applicable to the data packet.

8. A method according to claim 7, characterized in that preceding the step of selecting a rule applicable to the data packet it comprises the further steps of:
collecting packet fragments from a fragmented packet until a fragment header of said packet is received,
storing in an entry means information present in a fragment header field of the packet, and
forwarding packet fragments provided with fragment header information starting with the fragment header, wherein each fragment is processed by the filtering means as a regular unfragmented packet.

9. A method according to claim 7 or 8, characterized in that preceding the step of performing a rule matching it comprises the further step of:
depending on the information in the prefix, translating the external source address to an internal source address of a packet to be transmitted in through the firewall (3).

10. A method according to any of the preceding claims 7-9, characterized in that preceding the step of performing a rule matching it comprises the further step of:
depending on the information in the prefix, translating the external source address to an internal source address of a packet to be transmitted from the external network (4) to the internal network (1,5).

11. A method according to to any of the preceding claims claims 7-10, characterized by the further step of:
depending on the information in the prefix translating the internal source address to an external source address of a packet to be transmitted out through the firewall (3).

12. A method according to any of the preceding claims 7-11, characterized by the further step of:
depending on the information in the prefix translating the internal source address to an external source address of a packet to be transmitted from the internal network (4) to the external network (1).

13. A method according to any of the preceding claims 7-12, characterized in that preceding the step of performing a rule matching it comprises the further steps of:
based on the information in the prefix, determining if said packet is subject to a temporary exception from an external-to-internal blocking rule for a connection initiated from the internal network (1),
if so, establishing a return channel for packets transmitted from the external network (4) to the internal network (1) through the firewall (3), having a duration corresponding to the lifetime of the connection.

14. A method of controlling network data packet traffic between internal and external networks (1,5,4) through a firewall (3), comprising the steps of,
in dependence of the contents in the data fields of a data packet being transmitted between said networks, selecting from a total set of rules a rule applicable to the data packet,
applying said rule on said packet,
and depending on the rule blocking or forwarding said packet through the firewall (3), characterized in that preceding the step of selecting a rule applicable to the data packet it comprises the further steps of:
collecting packet fragments from a fragmented packet until a fragment header of said packet is received,
storing in an entry means information present in a fragment header field of the packet, and
forwarding packet fragments provided with fragment header information starting with the fragment header, wherein each fragment is processed by the filtering means as a regular unfragmented packet.
